(19) United States
(12) Patent Application Publication
(10) Pub. No.: US 2008/0158288 A1
(43) Pub. Date: Jul. 3, 2008

(54) RECORDING APPARATUS

(75) Inventors: Hideaki Nagahara, Yokohama-shi (JP); Naohiro Iwata, Yokohama-shi (JP); Kazuyuki Morinaga, Kawasaki-shi (JP); Yoshiaki Suzuki, Nagareyama-shi (JP); Hideyuki Terashima, Kawasaki-shi (JP); Akihiro Tomoda, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/961,792

(22) Filed: Dec. 20, 2007

(30) Foreign Application Priority Data
Dec. 28, 2006 (JP) 2006-354000

(51) Int. Cl. B41J 2/165

(52) U.S. Cl. 347/30

(57) ABSTRACT

A recording apparatus records information on a recording sheet by discharging ink from a recording head mounted on a carriage. The recording apparatus includes a trigger arm functioning as a trigger for starting transmission of a drive to a paper feeding unit and a pump drive transmission cam configured to interrupt transmission of the drive to a tube pump. The trigger arm and pump drive transmission cam are actuated in a state in which the recording head is in close contact with a cap in accordance with the position of the carriage.

### BACKGROUND OF THE INVENTION

1. Field of the Invention

The present invention relates to a recording apparatus that discharges ink from a recording head mounted on a carriage to record information.

2. Description of the Related Art

A recording apparatus that discharges ink using an ink jet recording head to record information can easily make a recording unit compact and can also record high-definition images at high speed. In addition, it can record information on a piece of ordinary paper without special processing. Such ink jet recording apparatus is also advantageous in that its running costs are low and its non-impact method leads to suppressed noise.

An ink jet recording apparatus includes a discharge recovering mechanism for recovering and maintaining the ability of a recording head to discharge ink. Examples of a method for recovering the discharge ability include a wiping operation of wiping a discharge port surface of the recording head and a sucking operation of sucking ink from the discharge port to renew ink inside the discharge port. The sucking operation sucks ink from the discharge port by producing a negative pressure using a sucking unit (e.g., a suction pump) connected to a cap sealing the discharge port of the recording head. Japanese Patent Laid-Open No. 2005-349779 (corresponding to US 2005/275705) discloses a structure that uses, as a driving unit for the sucking unit (suction pump), a conveying motor for driving a conveying roller that conveys a recording sheet.

A recording apparatus described in this patent document does not actuate the suction pump by blocking a drive from the conveying roller to the suction pump when the conveying roller is rotated in a forward direction to convey a recording sheet. When the conveying roller is rotated in a reverse direction, the recording apparatus drives the suction pump by transmitting the drive from the conveying roller to the suction pump. In response to an instruction to perform a recording operation, the recording apparatus first rotates the conveying roller in the reverse direction and performs a suction operation for the recording head to renew ink inside the discharge port prior to recording. Then, the recording apparatus moves a carriage on which the recording head is mounted to a predetermined position and rotates the conveying roller in the forward direction. The recording apparatus transmits the drive of the conveying roller rotated in the forward direction to a feeding roller by lowering a lever of an apparatus main body using a rib formed on the carriage and coupling gears and then feeds a sheet by rotation of the feeding roller. This feeding operation separates one from the recording sheets and transports the recording sheet to the conveying roller.

The recording sheet transported to the conveying roller is alternately subjected to be conveyed by the conveying roller and be recorded for one line by the recording head. Thus, recording on the entire recording sheet is completed. The recorded sheet is ejected from the apparatus main body by an ejecting roller driven in synchronization with the conveying roller.

However, the recording apparatus described in this patent document sucks out ink from the discharge port by transmitting the drive to the sucking unit when the conveying roller is rotated in the reverse direction in a state in which the cap is in close contact with the recording head. To prevent ink waste caused by an unnecessary suction operation, it is necessary to move the recording head to separate the recording head from the cap for rotation of the conveying roller in the reverse direction other than a suction recovery operation. As a result, it is impossible to rotate the conveying roller in the reverse direction in a capping state (cap-closed state) in which the recording head is in close contact with the cap, and this reduces throughput.

In addition, for a recording apparatus having the function of reading a document, a document feeding operation behaving similarly to the recording-sheet feeding operation may be performed. In this case, a triggering operation for starting the document feeding operation, for example, lowering the lever of the apparatus main body using a cam of the carriage is required, and therefore it is necessary to move the carriage to this triggering position. The movement of the carriage inevitably causes the recording head to be in a cap-open state. To protect the recording head, an operation for shifting to the cap-closed state is necessary to shift to the cap-open state, as in the case of the recording operation, and this reduces throughput.

### SUMMARY OF THE INVENTION

The present invention is directed to a recording apparatus capable of recording information with high quality and precision without reducing throughput.

According to an aspect of the present invention, a recording apparatus includes a recording head, a carriage, a paper feeding unit, a conveying roller, a motor, a cap, a sucking unit, a trigger arm, and a pump drive transmission cam. The recording head is configured to discharge ink onto a recording sheet to record information. The carriage is configured to move the recording head mounted thereon. The paper feeding unit is configured to feed the recording sheet. The conveying roller is configured to convey the recording sheet. The motor is configured to drive the conveying roller. The cap is capable of coming into contact with or separate from the recording head mounted on the carriage in accordance with movement of the carriage. The sucking unit is connected to the cap and configured to produce a negative pressure within the cap. The trigger arm controls whether the drive of the motor is transmitted to the paper feeding unit in accordance with the movement of the carriage. The pump drive transmission cam controls whether the drive of the motor is transmitted to the sucking unit in accordance with the movement of the carriage.

Further features of the present invention will become apparent from the following description of exemplary embodiments (with reference to the attached drawings).

### BRIEF DESCRIPTION OF THE DRAWINGS

FIG. 1 is a vertical sectional view that illustrates a general structure of an image reading and recording apparatus according to an embodiment of the present invention.

FIG. 2 is a perspective view of the image reading and recording apparatus.

FIG. 3 is a perspective view of the image reading and recording apparatus carrying a document.

FIG. 4 is a vertical sectional view that illustrates a reading unit and its surroundings during a reading operation.

FIG. 5 is a vertical sectional view that illustrates the reading unit and its surroundings during a recording operation.

FIG. 6 is a vertical sectional view that illustrates a state in which documents are set.

FIG. 7 is a vertical sectional view that illustrates a state in which recording sheets are set.

FIG. 8 is a perspective view of a drive transmission mechanism for transmitting a drive of a conveying motor to a conveying roller and a paper feeding unit.

FIGS. 9A and 9B are partial frontal views of a structure of the drive transmission mechanism from the conveying roller to the paper feeding unit; FIG. 9A illustrates a state in which the drive to the paper feeding unit is interrupted, and FIG. 9B illustrates a state in which the drive is transmittable to the paper feeding unit.

FIG. 10 is a perspective view of a recording head shown in FIG. 1 when viewed from obliquely below.

FIG. 11 is a perspective view that illustrates a state in which the carriage is in a basic position in a recording operation at a left end of a main body of the apparatus.

FIG. 12 is a perspective view that illustrates a drive transmission mechanism that transmits a drive to a discharge recovering portion in the image reading and recording apparatus.

FIG. 13 is a frontal view of a pump drive transmission cam.

FIGS. 14A and 14B illustrate a state in which the carriage is in a recording standby position; FIG. 14A is a perspective view of a drive transmission mechanism with the carriage indicated with dashed lines, and FIG. 14B is a frontal view that illustrates the carriage and its surroundings.

FIGS. 15A and 15B illustrate a state in which the carriage is in a recording-sheet feed position; FIG. 15A is a perspective view of the drive transmission mechanism with the carriage indicated with dashed lines, and FIG. 15B is a frontal view that illustrates the carriage and its surroundings.

FIGS. 16A and 16B illustrate a state in which the carriage is in a capping position; FIG. 16A is a perspective view of the drive transmission mechanism with the carriage indicated with dashed lines, and FIG. 16B is a frontal view that illustrates the carriage and its surroundings.

FIGS. 17A and 17B illustrate a state in which the carriage is in a recovery-drive non-transmission position; FIG. 17A is a perspective view of the drive transmission mechanism with the carriage indicated with dashed lines, and FIG. 17B is a frontal view that illustrates the carriage and its surroundings.

FIGS. 18A and 18B illustrate a state in which the carriage is in a document feed position; FIG. 18A is a perspective view of the drive transmission mechanism with the carriage indicated with dashed lines, and FIG. 18B is a frontal view that illustrates the carriage and its surroundings.

FIG. 19 illustrates an output waveform of a phase sensor for the pump drive transmission cam.

FIGS. 20A to 20C are partial frontal views of the drive transmission mechanism from the pump drive transmission cam to a sucking unit; FIG. 20A illustrates a state in which the sucking unit communicates with the air, FIG. 20B illustrates a neutral position, and FIG. 20C illustrates a state in which a negative pressure for suction is produced.

### DESCRIPTION OF THE EMBODIMENTS

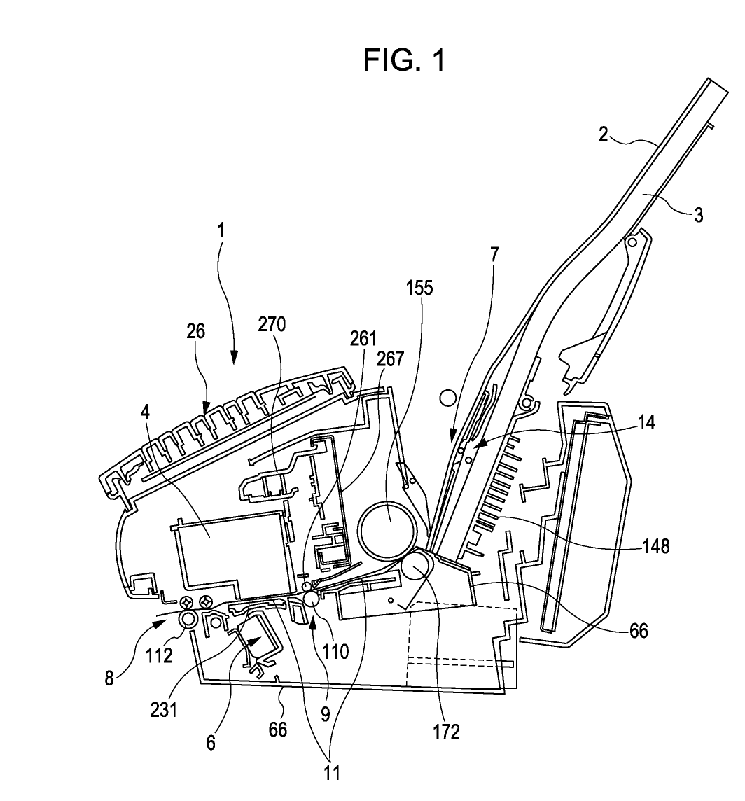

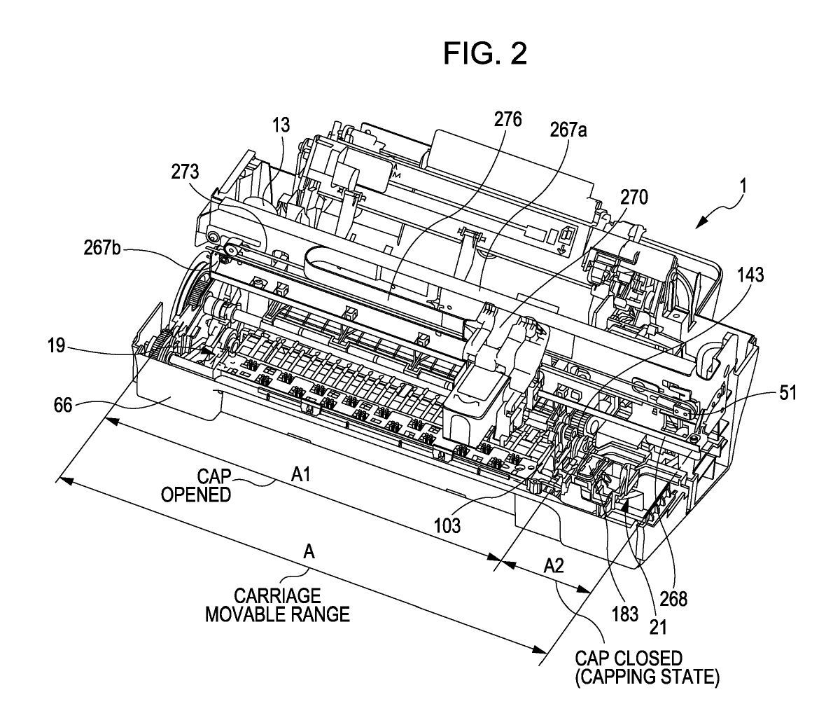

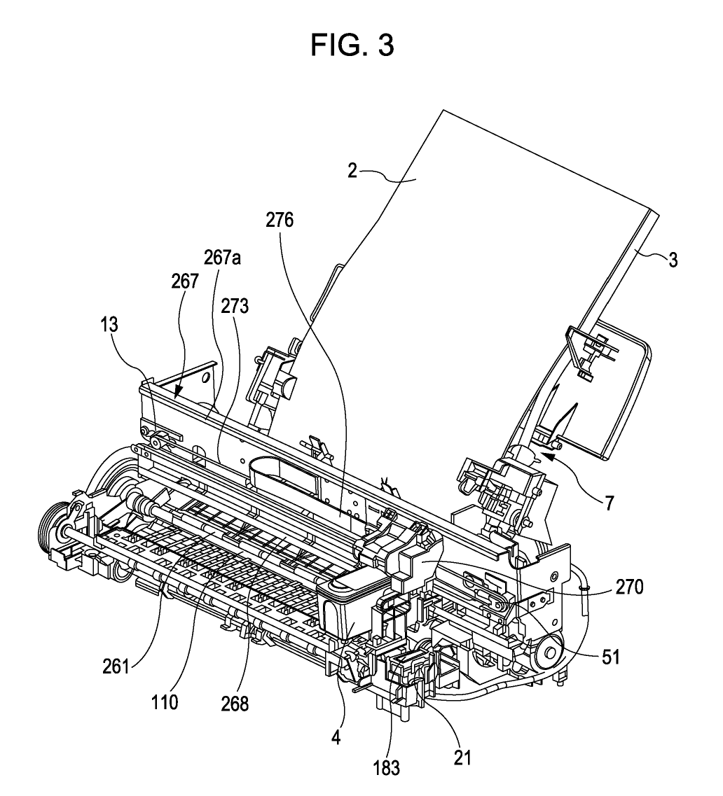

Embodiments of the present invention are specifically described with reference to the accompanying drawings, in which like reference characters designate the same or corresponding parts throughout the figures thereof. FIG. 1 is a vertical sectional view that illustrates a general structure of an image reading and recording apparatus according to an embodiment of the present invention. FIG. 2 is a perspective view of the image reading and recording apparatus. FIG. 3 is a perspective view of the image reading and recording apparatus carrying a document. Referring to FIGS. 1 to 3, the image reading and recording apparatus 1 includes a recording head 4 configured to record information on a recording sheet, a reading unit 6 configured to read a document, a paper feeding unit 7, an ejecting unit 8, and a conveying unit 9. The paper feeding unit 7 supplies a sheet of recording paper and a sheet of a document. The ejecting unit 8 ejects the recording sheet and the document. The conveying unit 9 conveys the recording sheet and the document. A discharge recovering portion 21 functions to recover the ability of the recording head 4 to discharge ink and maintain it. An operating panel 26 has a switch operable by a user and an indicator that indicates the operating state of the apparatus.

A recording operation of the image reading and recording apparatus 1 will now be described below. One or more recording sheets 3 placed on a sheet stacking portion 14 in the paper feeding unit 7 are transported by a feeding roller 155 and a pressure plate 148 pressed into contact with the feeding roller 155. The transported sheets 3 are separated one from another by the feeding roller 155 and a separation roller 172, and the separated recording sheet 3 is transported to the conveying unit 9. The transported recording sheet 3 is further transported (conveyed) from a conveying path 11 toward a conveying roller 110. Then, the recording sheet 3 is conveyed toward an ejecting roller 112 in the ejecting unit 8 through the conveying path 11 by the conveying roller 110 and a pinch roller 261 pressed into contact with the conveying roller 110.

During a recording operation, a platen 231 is disposed at a position that faces the recording head 4. The recording sheet 3 recorded by discharging of ink from the recording head 4 is ejected from the apparatus main body by the conveying roller 110 and the ejecting roller 112, and is placed on a tray or other similar receptacle. As illustrated in FIG. 2, the discharge recovering portion 21 for recovering the ability of the recording head 4 to discharge ink and maintaining it at a normal state is disposed within a moving range of a carriage 270 and at the right-hand side in the drawing outside a recording area where recording is performed on a recording sheet.

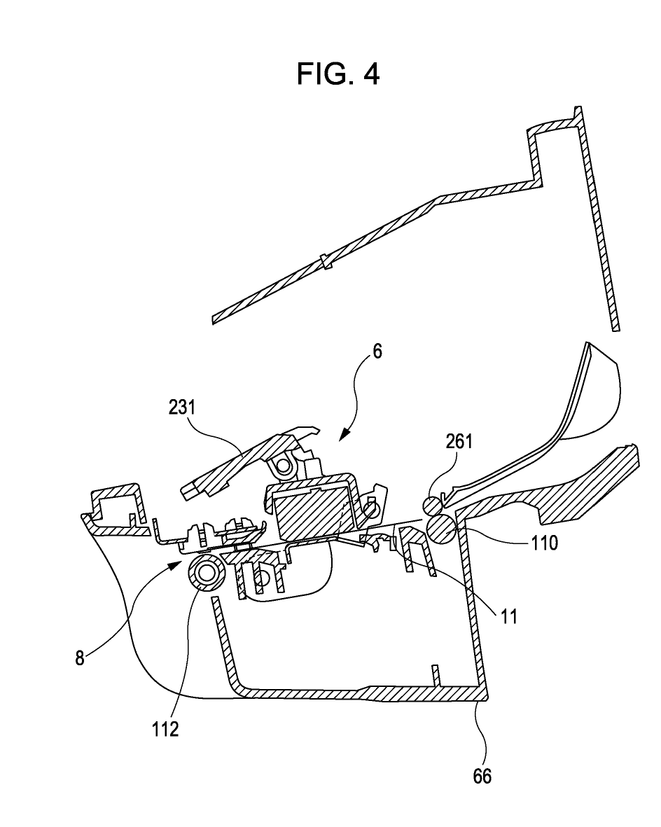

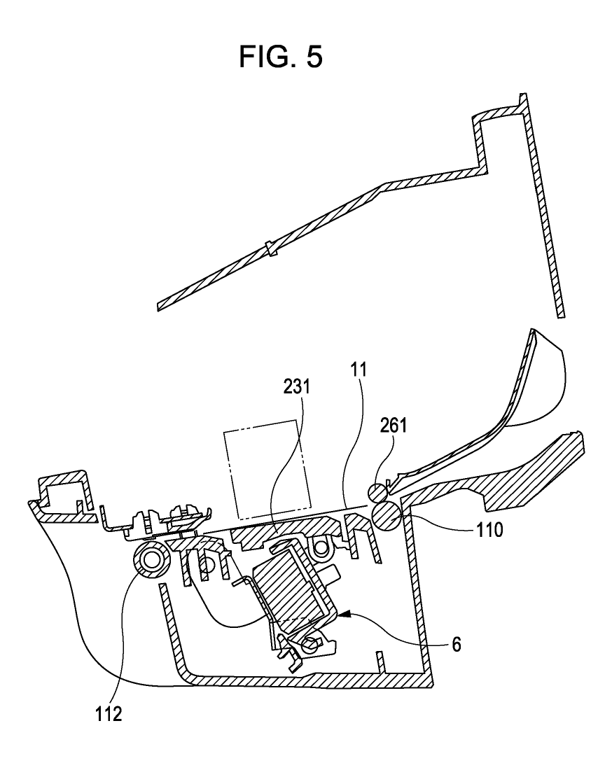

FIG. 4 is a vertical sectional view that illustrates the reading unit 6 and its surroundings during a reading operation. FIG. 5 is a vertical sectional view that illustrates the reading unit 6 and its surroundings during a recording operation. During a standby state in which neither a recording operation nor a reading operation is performed, the reading unit 6 for reading a document 2 in the image reading and recording apparatus 1 is in a state illustrated in FIG. 4. When an instruction to start recording is issued in response to an operation of the operating panel 26 in a standby state illustrated in FIG. 4, the reading unit 6 is moved to a withdrawal position below the conveying path 11, and the state is shifted to a state illustrated in FIG. 5. After that, the recording operation described above is started. When the recording operation has been completed, the reading unit 6 is moved from below to above the conveying path 11 and is positioned in a state illustrated in FIG. 4. When the reading unit 6 is situated above the conveying path 11 or is moving, the carriage 270 is situated at a withdrawn position outside a sheet conveying region at the right-hand side in the apparatus illustrated in FIG. 2. Thus, the carriage 270 does not interfere with the reading unit 6. In the standby state, the carriage 270 faces the discharge recovering portion 21, and degradation in the ink discharge ability is suppressed by causing a cap 183 to be in contact with a discharge surface 4e (FIG. 10) of the recording head 4.

A reading operation of the image reading and recording apparatus 1 will now be described with reference to FIGS. 1 to 4. As illustrated in FIG. 4, during a standby state, the reading unit 6 is positioned above the conveying path 11. When an instruction to read an image is issued in response to an operation of the operating panel 26 from a user or other similar action, one or more documents 2 placed on the sheet stacking portion 14 of the paper feeding unit 7 are transported by the feeding roller 155 and the pressure plate 148. The transported documents 2 are separated one from another by the feeding roller 155 and the separation roller 172, as in the case of the recording sheets 3. After the separated document 2 is transported to the conveying roller 110, the document 2 is read by the reading unit 6 while being conveyed along the conveying path 11 by the conveying roller 110 and the ejecting roller 112. After the completion of the reading operation, the document 2 is ejected from the apparatus main body by the conveying roller 110 and the ejecting roller 112. During the reading operation, the recording head 4 is maintained at a capping state in which the cap 183 is in close contact with the recording head 4 at a location that faces the discharge recovering portion 21.

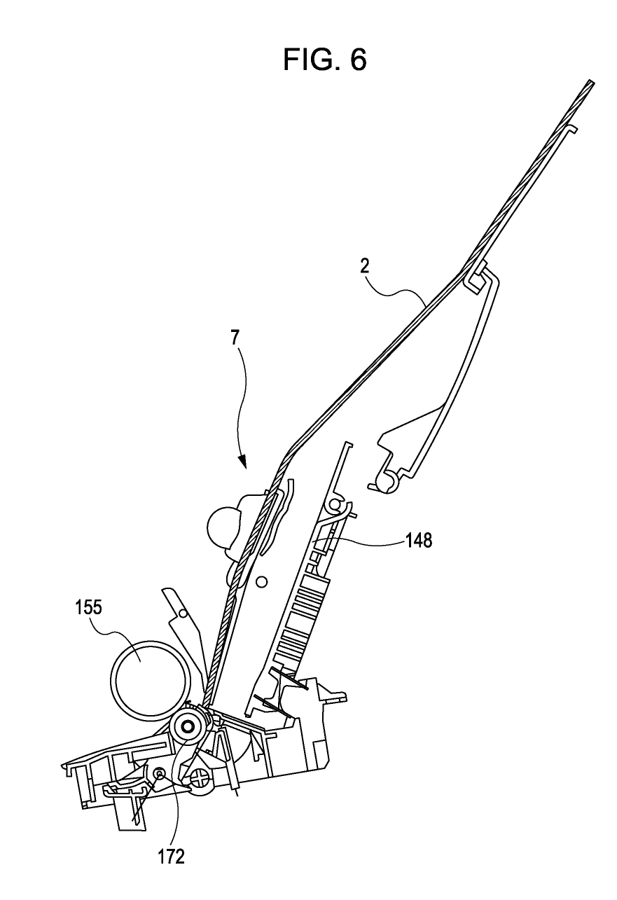

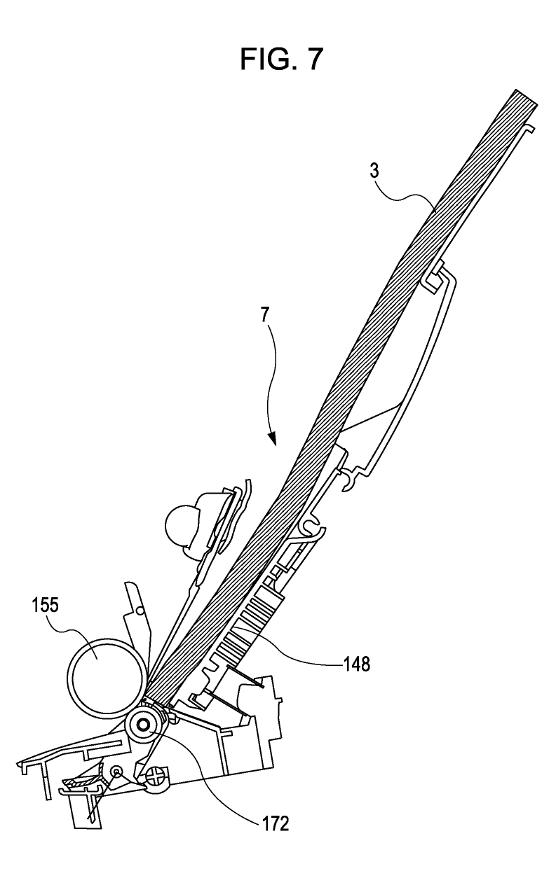

FIG. 6 is a vertical sectional view that illustrates a state in which the documents 2 are set in the image reading and recording apparatus 1. FIG. 7 is a vertical sectional view that illustrates a state in which the recording sheets 3 are set in the image reading and recording apparatus 1. The paper feeding unit 7 will now be described below. When the recording sheets 3 or the documents 2 (referred to simply as sheets) are pressed by the feeding roller 155 in response to an operation of the pressure plate 148 at a predetermined timing, the feeding roller 155 is driven so as to be rotated. This causes the uppermost sheet in contact with the feeding roller 155 to be transported by frictional force of the feeding roller 155. Examples of the material of the feeding roller 155 include a rubber having a high coefficient of friction (e.g., ethylene propylene diene monomer (EPDM)) and a urethane foam to enable a sheet to be transported by frictional force. In most cases, only the uppermost sheet is transported by the rotation of the feeding roller 155 because frictional force between the feeding roller 155 and the sheet is larger than frictional force between the sheets. However, if rough edges are left on the sheets after cutting or the sheets are stuck together by static electricity, or further, if sheets having a significantly high coefficient of friction are used, the rotation of the feeding roller 155 may transport a plurality of sheets.

When no sheet is present between the feeding roller 155 and the separation roller 172, the separation roller 172 is rotated so as to follow the rotation of the feeding roller 155. When a single sheet is inserted between the feeding roller 155 and the separation roller 172, because the frictional force between the feeding roller 155 and the sheet is larger than the frictional force between the sheet and the separation roller 172 being rotated so as to follow the rotation with a predetermined torque, the sheet is transported while causing the separation roller 172 to be rotated so as to follow the sheet. In contrast, when two sheets are inserted between the feeding roller 155 and the separation roller 172, because the frictional force between the feeding roller 155 and the adjacent sheet is larger than both the frictional force between the separation roller 172 and the adjacent sheet and the frictional force between the sheets, slipping occurs between the sheets.

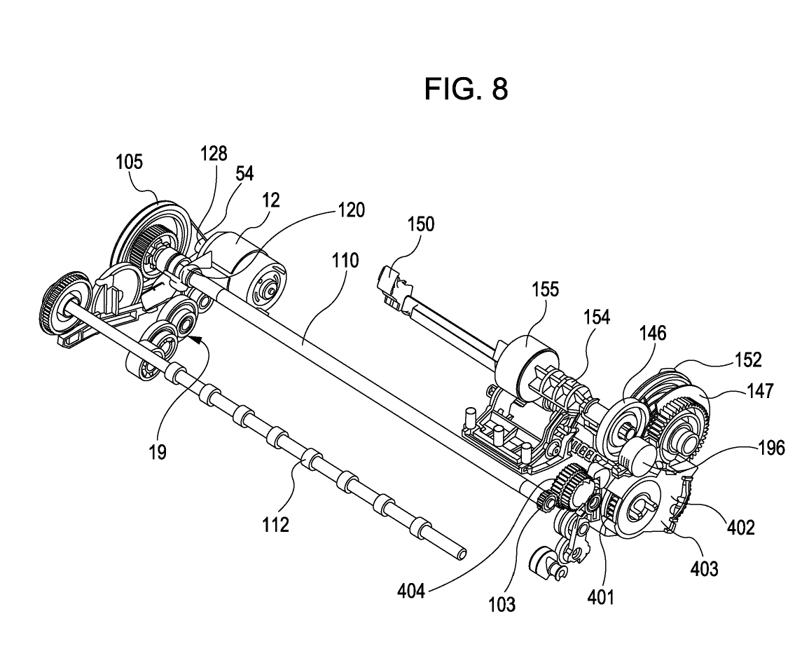

When three or more sheets are inserted between the feeding roller 155 and the separation roller 172, a plurality of sheets may be transported at a time. To avoid this, a return lever 150 (FIG. 8) is provided on a path over which sheets flow (path of sheets) adjacent to the feeding roller 155. The return lever 150 is positioned so as to close the path of sheets during a standby state. After a paper feeding operation starts, the return lever 150 is pivoted to the withdrawal position and opens the path of sheets. After the completion of separation of sheets, the return lever 150 is pivoted so as to return the second and subsequent sheets present in a nip between the feeding roller 155 and the separation roller 172 to the sheet stacking portion. After the return lever 150 finishes returning the sheets, the return lever 150 is pivoted to a position withdrawn from the path of sheets. When the rear end of the sheet reaches a position downstream from a predetermined point in the conveying direction, the return lever 150 returns to the original standby-state position again.

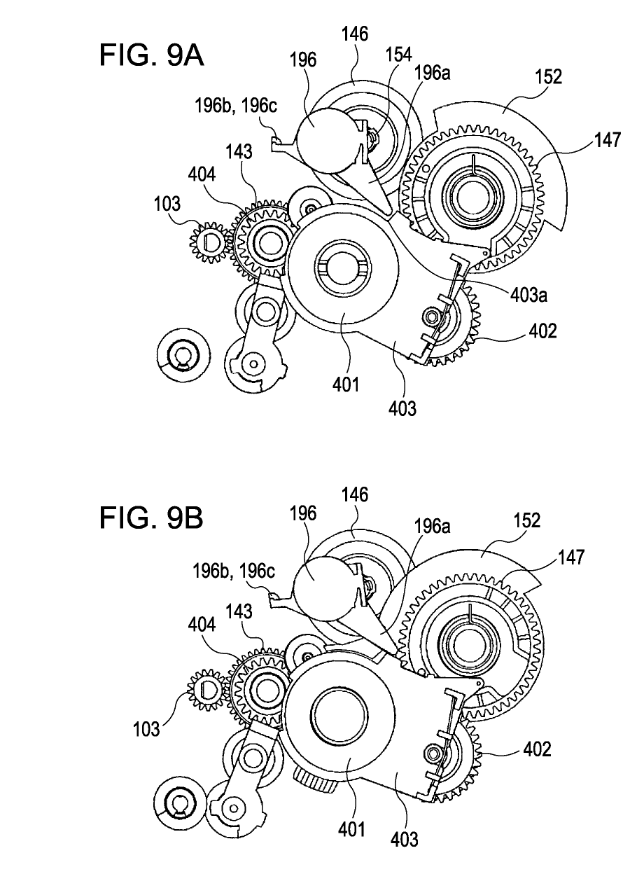

In the image reading and recording apparatus 1, the paper feeding unit 7 and the discharge recovering portion 21 can be driven by a conveying motor that drives the conveying roller 110. FIG. 8 is a perspective view that illustrates a structure of a drive transmission mechanism for transmitting a drive of a conveying motor 12 to the conveying roller 110 and the paper feeding unit 7. FIGS. 9A and 9B are partial frontal views of a structure of the drive transmission mechanism from the conveying roller 110 to the paper feeding unit 7. FIG. 9A illustrates a state in which the drive to the paper feeding unit 7 is interrupted. FIG. 9B illustrates a state in which the drive is transmittable to the paper feeding unit 7. FIGS. 8 and 9 illustrate the conveying motor 12, the conveying roller 110, a driving pulley 128, a conveying-roller pulley 105, a conveyance output gear 103, an idler gear 404, a sun gear 401, a planetary gear 402, a planetary arm 403, a feed shaft gear 146, a feed shaft 154, and the feeding roller 155. The drive force of the conveying motor 12 output from the driving pulley 128 is transmitted to the conveying roller 110 via a belt 54 and the conveying-roller pulley 105. The drive force of the conveying roller 110 is transmitted to the planetary gear 402 via the conveyance output gear 103, the idler gear 404, and the sun gear 401.

Referring to FIGS. 8 and 9, a trigger arm 196 functions to selectively enable and disable transmission of the drive to the paper feeding unit 7. The trigger arum 196 is pivotally supported and is urged in a clockwise direction in FIGS. 9A and 9B by a spring (not shown). The sun gear 401 and the planetary gear 402 are supported on the planetary arm 403 and mesh with each other. Friction is applied to the rotation of the planetary gear 402. In response to the rotation of the sun gear 401, the planetary arm 403 is pivoted (swung) about the sun gear 401. By use of this swinging movement, the transmission of the drive from the planetary gear 402 to the feed shaft gear 146 can be enabled and disabled. In the present embodiment, the transmission of the drive is selectively enabled and disabled by regulation of the swinging movement of the planetary arm 403 using the trigger arm 196.

In a state in which the drive is not transmitted to the paper feeding unit 7 (standby state) illustrated in FIG. 9A, an arm portion 196a of the trigger arm 196 pivoted clockwise by the urging force of the spring is engaged with a depression 403a of the planetary arm 403. When the conveying roller 110 (conveyance output gear 103) is rotated in a forward direction (counterclockwise in the drawing), the sun gear 401 is then rotated counterclockwise. In response to this, the planetary arm 403 and the planetary gear 402 initially attempt to be rotated counterclockwise, but the rotation is blocked by the arm portion 196a of the trigger arm 196. As a result, the drive is not transmitted to a control gear 147. Similarly, when the conveying roller 110 (conveyance output gear 103) is rotated in a reverse direction (clockwise), the arm portion 196a of the trigger arm 196 blocks the movement of the planetary arm 403. That is, in the standby state illustrated in FIG. 9A, the planetary arm 403 is not moved counterclockwise, and the drive is not transmitted to the paper feeding unit 7 when the conveying roller 110 is rotated in either of the forward and reverse directions.

In a state illustrated in FIG. 9B, the trigger arm 196 has been pivoted in a counterclockwise direction in the drawing against the urging force of the spring by a first lever portion 196b or a second lever portion 196c being pressed downward. Thus, the arm portion 196a of the trigger arm 196 is separated from the depression 403a of the planetary arm 403, and the trigger arm 196 is in a disengaged state. When the conveying roller 110 in a state illustrated in FIG. 9B is rotated in the forward direction, the sun gear 401 is then rotated counterclockwise, and the planetary arm 403 is also pivoted counterclockwise. This causes the planetary gear 402 to mesh with the control gear 147. Because the control gear 147 meshes with the feed shaft 154, the forward drive of the conveying roller 110 is transmitted to the feeding roller 155 via the feed shaft gear 146 and the feed shaft 154, and the feeding roller 155 is rotated in the clockwise direction in the drawing.

A control cam 152 incorporates a one way clutch for preventing rotation in the clockwise direction in the drawings. This aims to prevent the feeding roller 155 from being rotated in the reverse direction when the conveying roller 110 is made to be rotated in the reverse direction during feeding of a sheet (in particular, recording sheet 3) to correct undesired oblique passage thereof. The planetary gear 402 includes two coaxial gear elements, and a clutch mechanism is arranged therebetween. The clutch mechanism functions to enable the transmission of the drive for the forward rotation of the conveying roller 110 and to disable the transmission of the drive for the reverse rotation of the conveying roller 110. By use of such a fixing mechanism of the planetary arm 403, advantageously, the carriage can be positioned in any location after the trigger arm 196 is set in position, thus allowing other operations to be performed during the state.

A read-drive sun gear 120 (see FIG. 8) is disposed on the shaft of the conveying roller 110. The read-drive sun gear 120 functions to transmit the drive to a read switching unit 19 for pivoting the reading unit 6 between a reading position and the withdrawal position. The read-drive sun gear 120 is disposed between the conveying-roller pulley 105 and a sheet conveying area.

FIG. 10 is a perspective view of the recording head 4 when viewed from obliquely below. The recording head 4 is of the cartridge type where the recording head is formed integrally with one or more ink tanks. The recording head 4 includes the discharge surface 4e having a plurality of discharge ports 4a formed in a predetermined arrangement at the lower surface.

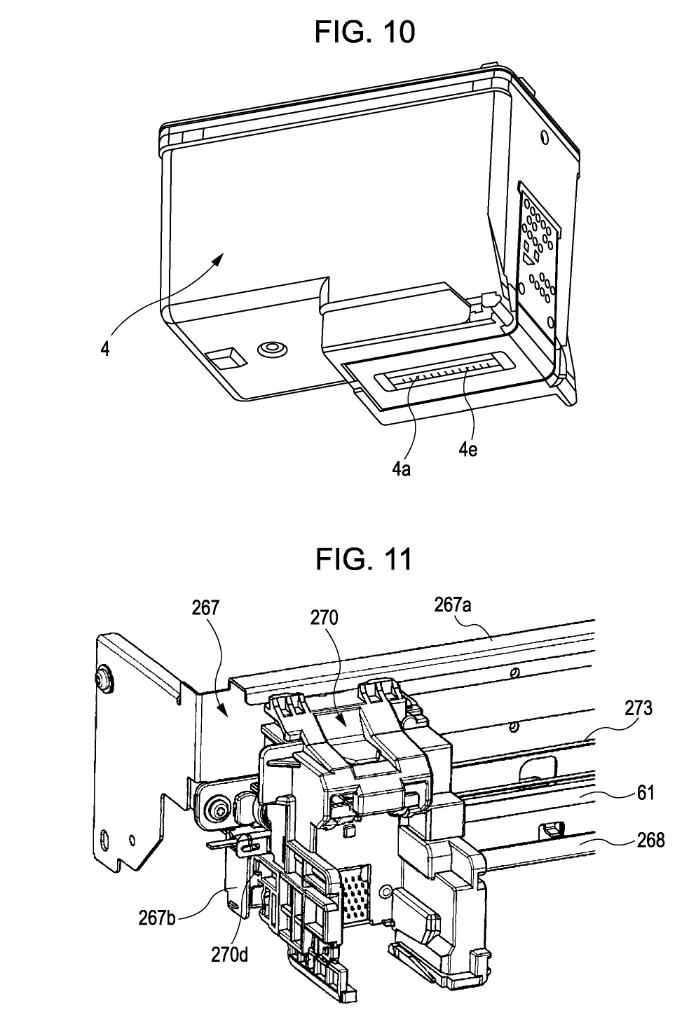

FIG. 11 is a perspective view that illustrates a state in which the carriage 270 is in a basic position for a recording operation at the left end of the apparatus main body. The carriage 270 is supported and guided by a chassis rail 268 disposed on a chassis 267 and a support rail 267a of the chassis 267. The drive of a carriage motor 13 is transmitted to the carriage 270 via a carriage belt 273 looped over a driving pulley and an idler pulley 51, thereby causing the carriage 270 to reciprocate. The recording head 4 receives a signal from a head driver of an electric substrate via a flexible flat cable 276. Based on image information, ink is discharged from the discharge ports 4a, thus recording an image on the recording sheet 3.

A code strip 61 extends in parallel to the chassis rail 268. Ink can be discharged onto a recording sheet with an appropriate timing by reading of the code strip 61 using an encoder mounted on the carriage 270.

The basic position illustrated in FIG. 11 can also be used as a maintenance position for replacing the recording head 4 with a new one. The carriage 270 is set at the basic position for a recording operation by causing an abutment portion 270d of the carriage 270 to come into contact with an abutment portion 267b of the left end of the chassis 267.

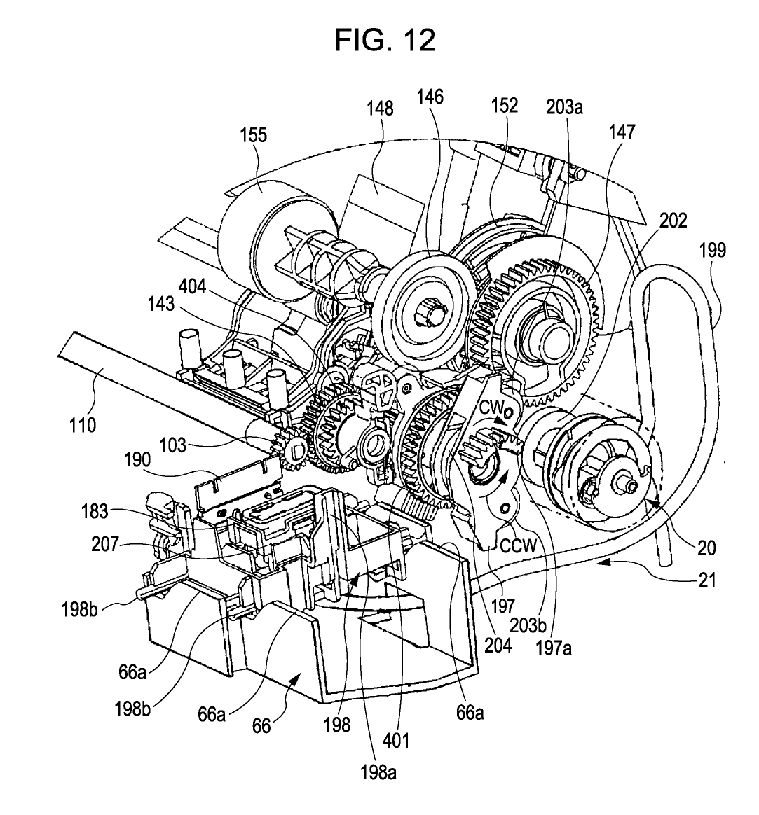

FIG. 12 is a perspective view that illustrates a drive transmission mechanism to the discharge recovering portion 21 in the image reading and recording apparatus. The discharge recovering portion 21 includes the cap 183 and a suction pump (tube pump) 20 connected to the cap 183. The cap is capable of coming into contact with the discharge surface 4e of the recording head 4 and covering the discharge ports 4a. Actuating the suction pump 20 while the discharge ports 4a are sealed by the cap 183 can suck and eject ink from the discharge ports 4a, thus restoring the properties of ink in the discharge ports 4a. The discharge recovering portion 21 also includes a wiper 190 for wiping the discharge surface 4e to remove matter (e.g., ink) attached thereon.

The cap 183 is supported on a cap holder 207. The cap holder 207 is supported on a cap slider 198 so as to be able to be vertically moved and guided. A cap spring (not shown) for causing the cap 183 to come into contact with the recording head 4 with a predetermined pressing force is disposed between the cap holder 207 and the cap slider 198. The cap slider 198 includes a contact portion 198b slidable along a cam surface 66a formed as a rib of a base 66. The cap slider 198 is spring-urged by a cap-slider spring extending to a part of the base 66 such that the contact portion 198b slides on the cam surface 66a.

The cap slider 198 also includes an abutment portion 198a capable of being made to come into contact with the carriage 270. When the carriage 270 is moved from the left-hand side in the drawing to a region of the discharge recovering portion 21, the carriage 270 comes into contact with the abutment portion 198a, thereby causing the cap slider 198 to be moved so as to follow the carriage 270. At this time, together with the movement of the carriage 270 to the right-hand side in the drawing, the cap slider 198 is moved vertically (upward) along the cam surface 66a toward the recording head 4. This ascent of the cap slider 198 causes the cap 183 to come into contact with the discharge surface 4e of the recording head 4 via the cap spring, and the discharge surface 4e is capped (a capping state). The position of the carriage 270 in this capping state is referred to as the capping position. When the carriage 270 is moved from the capping position in a reverse direction (a direction to return to the recording area), the cap slider 198 is moved in a direction to return to the original position (standby position) by the urging force of the cap-slider spring and is moved downward. With this descent of the cap slider 198, the cap 183 is separated from the discharge surface 4e, and the discharge ports 4a are opened (cap-open state).

As illustrated in FIG. 12, the drive from the conveying motor 12 is transmitted to the tube pump 20 via the conveying roller 110, the conveyance output gear 103, an idler gear 143, and the sun gear 401. A pump sun gear 204 is rotated integrally with the sun gear 401 in engagement therewith. The drive is transmitted to the tube pump 20 via a drive system in which the pump sun gear 204, a first pump pendulum gear 203a, and a second pump pendulum gear 203b are rotatably supported in a pump pendulum arm 197 so as to be able to swing and rotate about the pump sun gear 204 integrally with each other.

That is, the sun gear 401 is rotated in a direction indicated by “ccw” in the drawing (the direction in which the conveying roller 110 conveys a sheet, i.e., forward direction), the pump sun gear 204 is also rotated counterclockwise in the drawing, and the pump pendulum arm 197 is swung counterclockwise in the drawing. Thus, the second pump pendulum gear 203b meshes with a pump drive gear 202, and this drives the tube pump 20 in a direction that communicates with the air. In contrast, when the sun gear 401 is rotated in a direction indicated by “cw” in the drawing (a direction opposite the direction in which the conveying roller 110 conveys a sheet, i.e., reverse direction), the pump sun gear 204 is also rotated clockwise in the drawing, and the pump pendulum arm 197 is swung clockwise in the drawing. Thus, the first pump pendulum gear 203a meshes with the pump drive gear 202, and this drives the tube pump 20 in a direction that produces a negative pressure. That is, the suction pump is driven in a suction direction in which a negative pressure is produced by pressing a tube 199 into a close contact state and squeezed.

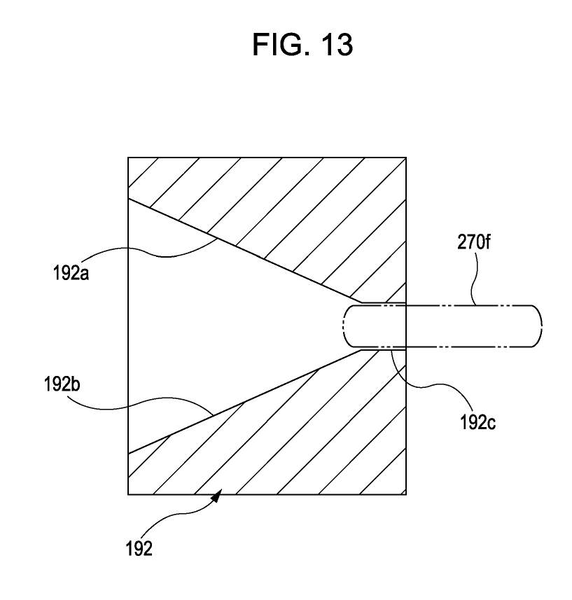

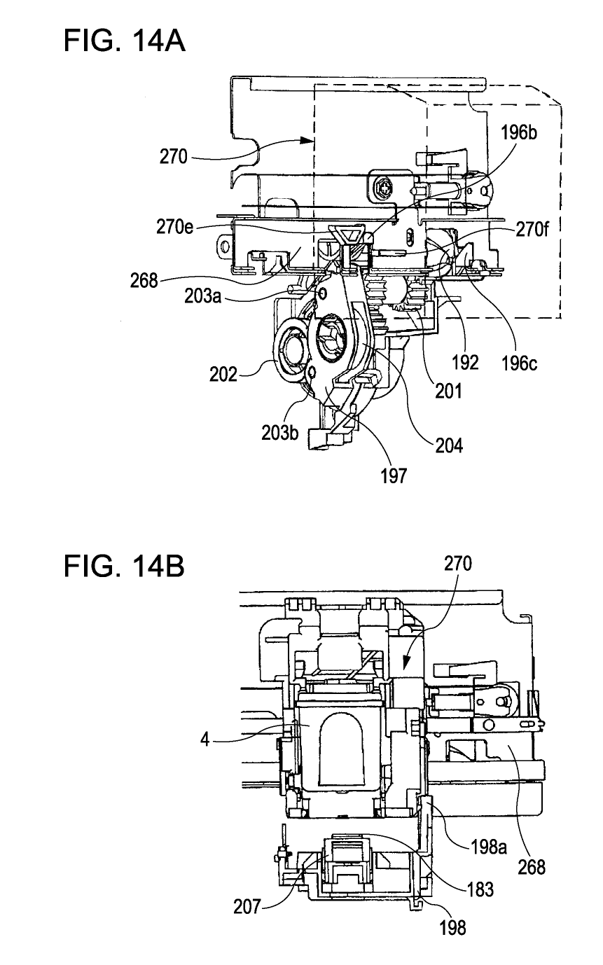

The pump pendulum arm 197 also includes a gear portion 197a coaxial with the pump sun gear 204. The gear portion 197a is gear-coupled to a pump drive transmission cam 192 via a relay gear 201 (FIG. 14A). FIG. 13 is a frontal view of the pump drive transmission cam 192. The pump drive transmission cam 192 is a clutch unit for interrupting transmission of the drive to the tube pump 20. The pump drive transmission cam 192 includes cam surfaces 192a and 192b and a slot 192c. The pump drive transmission cam 192 is pivotally disposed. The cam surfaces 192a and 192b and the slot 192c are exposed from an opening of the chassis rail 268 (e.g., FIGS. 14A and 14B) of the chassis 267. The carriage 270 includes a second cam portion 270f (FIGS. 13 and 14A) on the back thereof. When the carriage 270 is moved rightward in the apparatus main body, the second cam portion 270f rotates the pump drive transmission cam 192 while sliding on the cam surface 192a or 192b of the pump drive transmission cam 192, and finally, is fit in the slot 192c.

When the second cam portion 270f of the carriage 270 is fitted in the slot 192c, the state is a neutral state in which neither the first pump pendulum gear 203a nor the second pump pendulum gear 203b meshes with the pump drive gear 202. When the second cam portion 270f is fitted in the slot 192c, the movement of the pump pendulum arm 197 is restricted, and thus, the drive cannot be transmitted to the tube pump 20. When the carriage 270 is moved leftward and the engagement of the second cam portion 270f with the slot 192c is released, the pump pendulum arm 197 can be freely swung. Thus, the drive is transmittable to the tube pump 20.

A control of the operation of the discharge recovering portion 21 and the operation of the paper feeding unit 7 utilizing the position of the carriage 270 and the rotary driving of the conveying motor 12 in combination will now be described below. In the trigger arm 196, the arm portion 196a, the first lever portion 196b, and the second lever portion 196c are pivotable integrally with each other. The arm portion 196a can be engaged with the depression 403a of the planetary arm 403. The first lever portion 196b and the second lever portion 196c protrude above the chassis rail 268, which is the path of movement of the carriage 270, and are arranged so as to be pivotable by being made to come into contact with the carriage 270. The first lever portion 196b, the second lever portion 196c, and the pump drive transmission cam 192 are arranged in the right-hand side to the recording area in the apparatus main body. The first lever portion 196b, the pump drive transmission cam 192, and the second lever portion 196c are arranged in this order from the recording area.

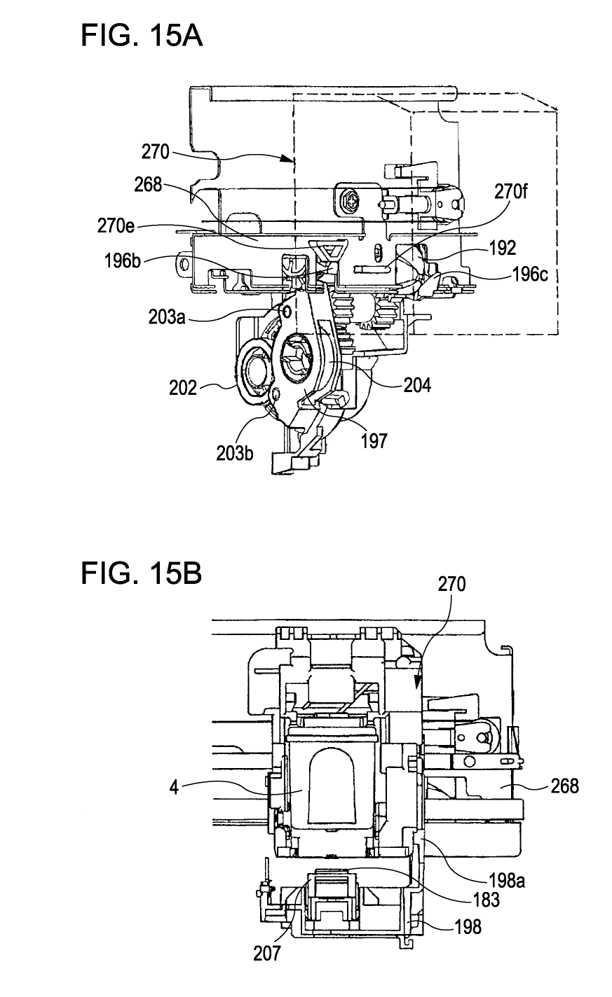

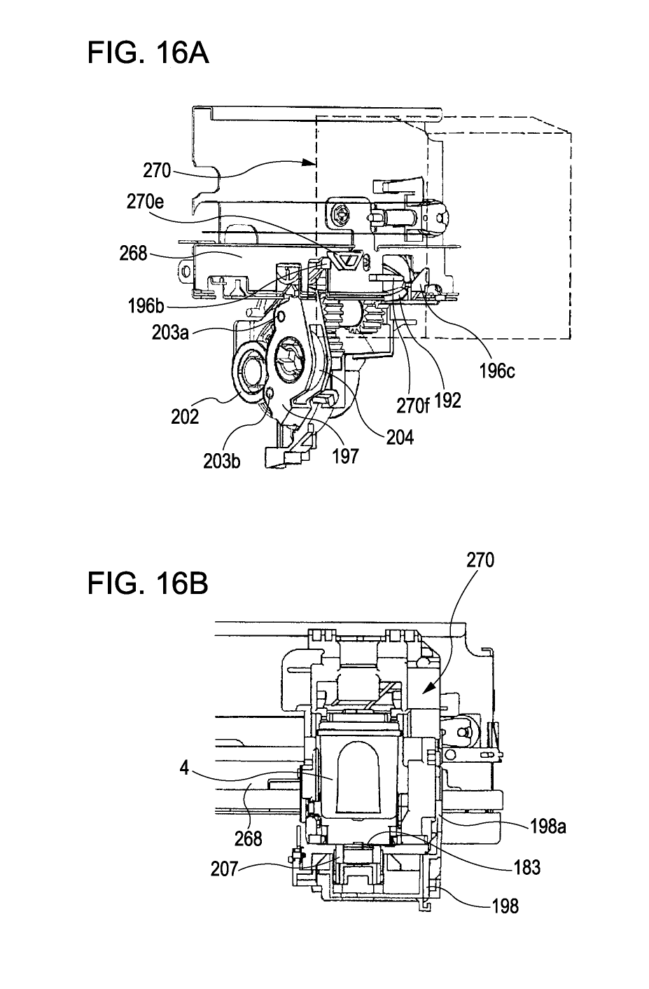

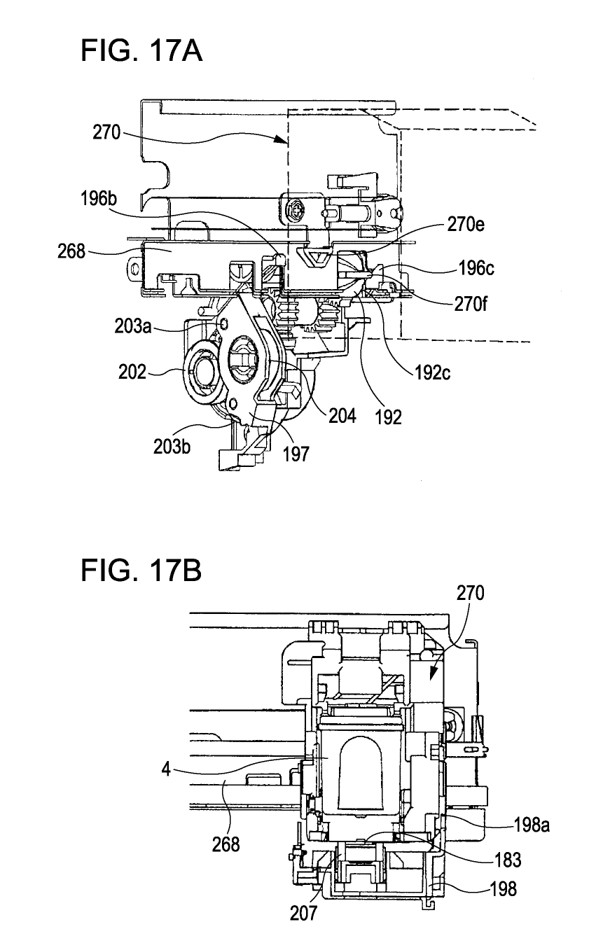

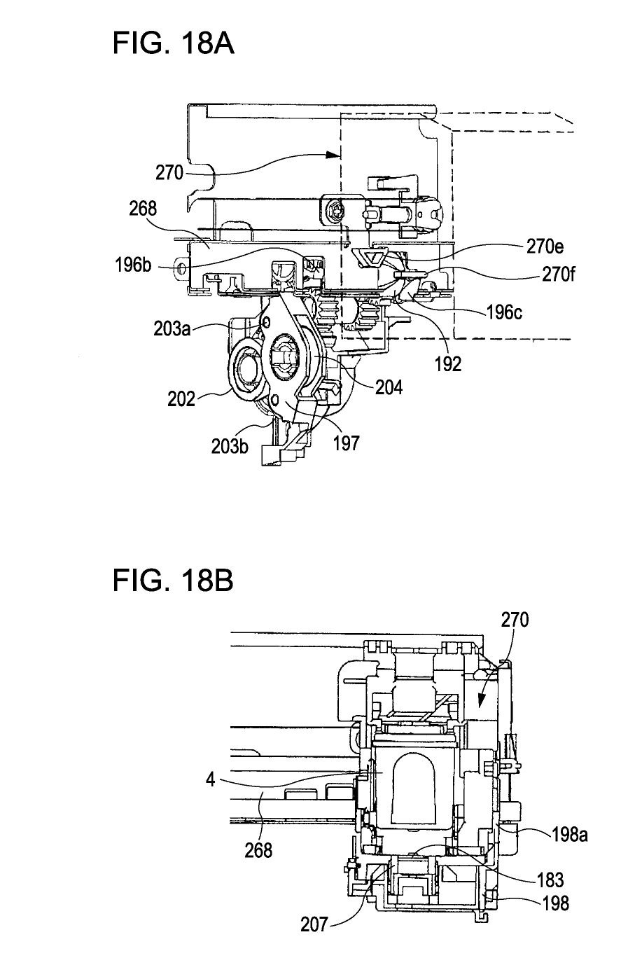

FIGS. 14 to 18 illustrate the relationship among the movement of the carriage 270, the trigger arm 196, and the pump drive transmission cam 192. FIGS. 14A, 15A, 16A, 17A, and 18A are perspective views of a drive transmission mechanism with the carriage 270 indicated with dashed lines. FIGS. 14B, 15B, 16B, 17B, and 18B are frontal views that illustrate the carriage 270 and its surroundings. FIGS. 14A and 14B illustrate a state in which the carriage 270 is in a recording standby position. FIGS. 15A and 15B illustrate a state in which the carriage 270 is in a recording-sheet feed position. FIGS. 16A and 16B illustrate a state in which the carriage 270 is in a capping position. FIGS. 17A and 17B illustrate a state in which the carriage 270 is in a recovery-drive non-transmission position. FIGS. 18A and 18B illustrate a state in which the carriage 270 is in a document feed position. FIGS. 14 and 15 illustrate the cap-open state, in which the cap 183 is separated from the recording head 4. FIGS. 16 to 18 illustrate the cap-closed state (capping state), in which the cap 183 is in contact with the recording head 4.

A state in which the carriage 270 is sequentially moved from the recording standby position to each position in a rightward direction in a right-hand region outside the recording area will now be described below. At the recording standby position illustrated in FIGS. 14A and 14B, the cap 183 faces the discharge surface 4e of the recording head 4 and is separated therefrom. At this position, a first cam portion 270e and the second cam portion 270f on the back of the carriage 270 are engaged with none of the first lever portion 196b and the second lever portion 196c of the trigger arm 196 and the pump drive transmission cam 192. In this state, transmission of the drive from the conveying motor 12 to the paper feeding unit 7 is interrupted, whereas the drive is transmittable to the tube pump 20. At this time, when the conveying roller 110 is rotated in the sheet conveying direction, the tube pump 20 is driven in a direction that communicates with the air; when the conveying roller 110 is rotated in the reverse direction, the tube pump 20 is driven in a direction in which a negative pressure is produced. The paper feeding unit 7 is not driven. Even when a negative pressure is produced by the tube pump 20, ink is not sucked from the discharge ports 4a because the cap 183 is separated from the recording head 4.

At the recording-sheet feed position illustrated in FIGS. 15A and 15B, the cap 183 faces the discharge surface 4e of the recording head 4 and is separated therefrom. With movement of the carriage 270 from the recording standby position in the rightward direction, the first lever portion 196b is pressed downward along the cam surface of the first cam portion 270e against the urging force of the spring. At this position, the first cam portion 270e of the carriage 270 is engaged with the first lever portion 196b of the trigger arm 196. In this state, the drive from the conveying motor 12 is transmittable to the paper feeding unit 7, and feeding a sheet (recording sheet) is started by driving of the conveying motor 12 in the forward direction. The drive is also transmittable to the tube pump 20. The operation of the tube pump 20 at this time is the same as that occurring in the recording standby position described above. The position illustrated in FIGS. 15A and 15B is a position where transmission of the drive to the paper feeding unit 7 is started by engagement of the trigger arm 196 with the first cam portion 270e.

At the capping position illustrated in FIGS. 16A and 16B, the cap 183 faces the discharge surface 4e of the recording head 4 and is in contact therewith. With movement of the carriage 270 from the recording-sheet feed position in the rightward direction, the engagement of the first lever portion 196b with the first cam portion 270e is released, and the first lever portion 196b returns to an upward pressed state again by the urging force of the spring. At this position, the transmission of the drive from the conveying motor 12 to the paper feeding unit 7 is interrupted, whereas the drive is transmittable to the tube pump 20. In this case, the operation of the tube pump 20 itself is the same as that occurring in the recording standby position. At this position, because the cap 183 is in contact with the discharge surface 4e, ink can be sucked from the discharge ports 4a by driving of the conveying motor 12 in the reverse direction. This is a state in which the second cam portion 270f is engaged with neither the trigger arm 196 nor the pump drive transmission cam 192.

At the recovery-drive non-transmission position illustrated in FIGS. 17A and 17B, the cap 183 faces the discharge surface 4e and is in contact therewith. At this position, the cap 183 is in the capping state, but the discharge recovering portion 21 is not driven. With movement of the carriage 270 from the capping position illustrated in FIGS. 16A and 16B in the rightward direction, the pump drive transmission cam 192 is rotated while the second cam portion 270f slides on the cam surface 192a or 192b. The rotation is finally stopped when the second cam portion 270f is fitted in the slot 192c. In this way, the carriage 270 is brought into the recovery-drive non-transmission state illustrated in FIGS. 17A and 17B. At this position, the first lever portion 196b and the second lever portion 196c of the trigger arm 196 are engaged with neither the first cam portion 270e nor the second cam portion 270f of the carriage 270. The position illustrated in FIGS. 17A and 17B is a position where the second cam portion 270f is engaged with the pump drive transmission cam 192.

At the position illustrated in FIGS. 17A and 17B, the drive from the conveying motor 12 is transmitted to neither the paper feeding unit 7 nor the suction pump 20. According to the present embodiment, to move the carriage 270 to the position illustrated in FIGS. 17A and 17B from other positions, the carriage 270 is moved after being brought into a neutral state in which the pump pendulum arm 197 meshes with neither the first pump pendulum gear 203a nor the second pump pendulum gear 203b. This aims to reduce a load imposed on the carriage motor 13.

At the document feed position illustrated in FIGS. 18A and 18B, the cap 183 faces the discharge surface 4e and is in contact therewith. At this position, the transmission of the drive to the discharge recovering portion 21 is interrupted. At the document feed position illustrated in FIGS. 18A and 18B, the cap 183 is in the capping state, and the drive cannot be transmitted to the recovery system and the paper feeding unit 7 can be driven. With movement of the carriage 270 from the position illustrated in FIGS. 17A and 17B, at which the cap 183 is in the capping state and the drive cannot be transmitted to the recovery system, in the rightward direction, the second lever portion 196c of the trigger arm 196 is pressed downward along the cam surface of the second cam portion 270f against the urging force of the spring. The second cam portion 270f of the carriage 270 is engaged with the second lever portion 196c of the trigger arm 196.

As described above, the feeding operations of recording sheets and documents and the discharge recovery operation for the recording head can be controlled in combination by the movement of the carriage 270.

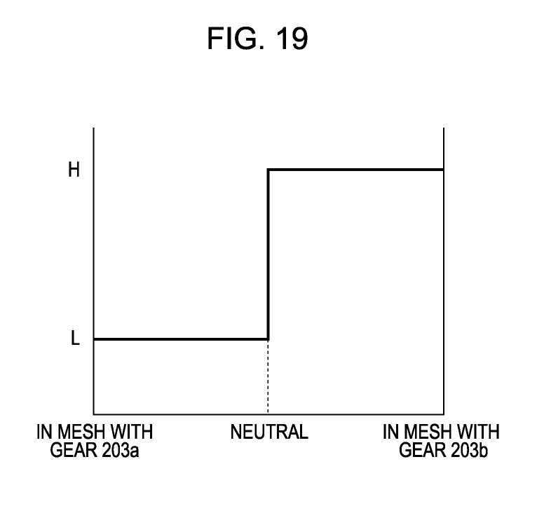

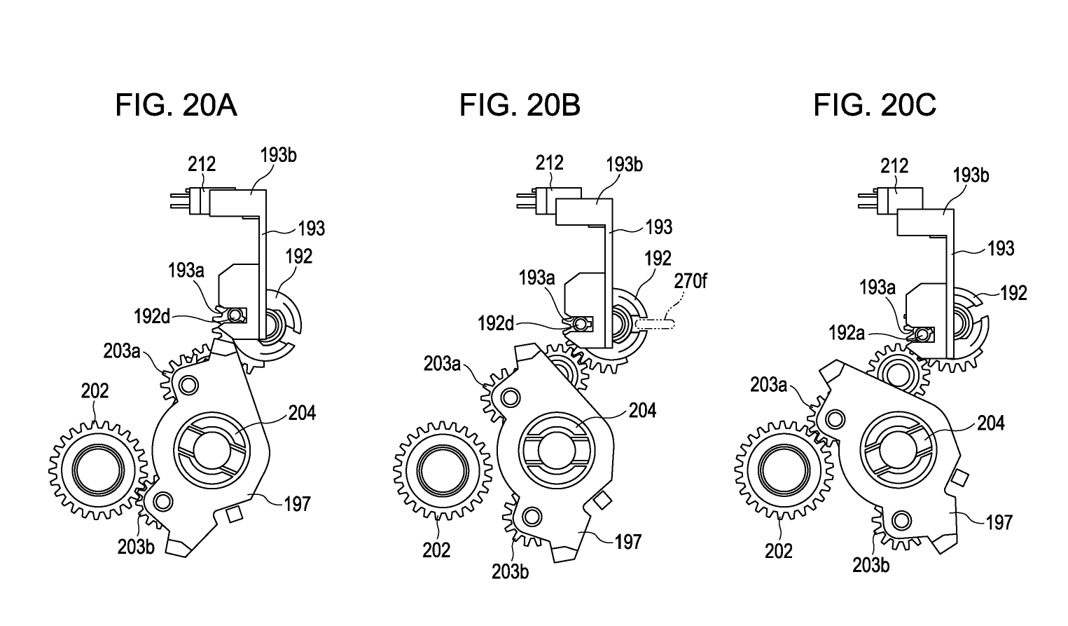

Enabling and blocking transmission of the drive to the tube pump 20 will now be described below. FIG. 19 illustrates an output waveform of a phase sensor for the pump drive transmission cam 192. FIGS. 20A to 20C are partial frontal views of the drive transmission mechanism from the pump drive transmission cam 192 to the tube pump 20. FIG. 20A illustrates a state in which the tube pump 20 communicates with the air. FIG. 20B illustrates a neutral position. FIG. 20C illustrates a state in which a negative pressure for suction is produced. The conveying roller 110 is driven by the conveying motor 12 via the conveying-roller pulley 105 (see, for example, FIG. 8). The read-drive sun gear 120 is fixed between the conveying-roller pulley 105 and a sheet conveying area on the conveying roller 110.

In the present embodiment, a sensor for detecting the phase of the pump drive transmission cam 192 is provided. The phase of the pump drive transmission cam 192 corresponds to the position of the pump pendulum arm 197. FIGS. 20A to 20C illustrate how this sensor is moved. A sensor lever 193 supports a boss 192d of the pump drive transmission cam 192 such that the boss 192d is fitted in a recess 193a. The sensor lever 193 can be moved upward and downward with rotation of the pump drive transmission cam 192. A light-shielding portion 193b for a photo-interrupter 212 is formed at a different end of the sensor lever 193. With the upward and downward movement of the sensor lever 193, enabling and blocking transmission of light along the optical axis of the photo-interrupter 212 is switched.

When the first pump pendulum gear 203a mashes with the pump drive gear 202 and the tube pump 20 produces a negative pressure, as illustrated in FIG. 20C, the light-shielding portion 193b is withdrawn from the optical axis of the photo-interrupter 212. In this state, light is transmitted, and an output of the sensor is at L, as illustrated in FIG. 19. In contrast, when the second pump pendulum gear 203b meshes with the pump drive gear 202 and the tube pump 20 communicates with the air, as illustrated in FIG. 20A, the light-shielding portion 193b lies in the optical axis of the photo-interrupter 212. In this state, light is blocked, and the output of the sensor is at H, as illustrated in FIG. 19. At a neutral position between the states described above, as illustrated in FIG. 20B, the light-shielding portion 193b functions to switch enabling and blocking of transmission of light along the optical axis (switch the output of the sensor).

For example, when the output of the sensor is L, the pump pendulum arm 197 is situated between the neutral position and a position at which the first pump pendulum gear 203a meshes with the pump drive gear 202. Thus, the pump drive transmission cam 192 can be shifted to the neutral position by rotation of the pump sun gear 204 from that position in a direction that approaches the neutral position, that is, in a counterclockwise direction in FIGS. 20A to 20C (a direction in which the conveying roller 110 conveys a sheet). In this operation, stopping the conveying motor 12 at the time the output of the sensor is switched from L to H enables the pump drive transmission cam 192 to be situated in the neutral position and thus enables the second cam portion 270f of the carriage 270 to be easily fitted (engaged) in the slot 192c. When the output of the sensor is H, the pump sun gear 204 is rotated in a direction opposite the above direction.

According to the embodiments described above, both the feeding operation of feeding a recording sheet and the feeding operation of feeding a document can be started while the recording head is capped. This can prevent unnecessary ink consumption. In addition, the discharge recovering portion can be prevented from being inadvertently driven while a recording sheet or a document is conveyed.

According to the embodiments, the feeding operation of the paper feeding unit can be started and the transmission of the drive to the sucking unit can be interrupted in a state in which the recording head is in close contact with the cap. As a result, the recording apparatus can record information with high quality and precision without reducing throughput.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-354000 filed Dec. 28, 2006, which is hereby incorporated by reference herein in its entirety.

What is claimed is:

1. A recording apparatus comprising:
a recording head configured to discharge ink onto a recording sheet to record information;
a carriage configured to move the recording head mounted thereon;
a paper feeding unit configured to feed the recording sheet;
a conveying roller configured to convey the recording sheet;
a motor configured to drive the conveying roller;
a cap capable of coming into contact with or separate from the recording head mounted on the carriage in accordance with movement of the carriage;
a sucking unit connected to the cap and configured to produce a negative pressure within the cap;
a trigger arm controlling whether the drive of the motor is transmitted to the paper feeding unit in accordance with the movement of the carriage; and
a pump drive transmission cam controlling whether the drive of the motor is transmitted to the sucking unit in accordance with the movement of the carriage.

2. The recording apparatus according to claim 1, further comprising:
a reading unit configured to read an image of a document, wherein the document is fed by the paper feeding unit and conveyed by the conveying roller.

3. The recording apparatus according to claim 2, wherein the trigger arm includes a first lever portion configured to trigger feeding the recording sheet by engaging with the carriage in a state in which the recording head and the cap are separated from each other.

4. The recording apparatus according to claim 3, wherein the trigger arm includes a second lever portion triggering feeding the document by engaging with the carriage in a state in which the recording head and the cap are in contact with each other.

5. The recording apparatus according to claim 4, wherein the carriage includes first and second cam portions, the first cam portion being configured to pivot the trigger arm by engaging with the first lever portion, and the second cam portion being configured to pivot the trigger arm by engaging with the second lever portion.

6. The recording apparatus according to claim 5, wherein the carriage is movable to a first position where the first lever portion and the first cam portion are engaged with each other and to a second position where the second lever portion and the second cam portion are engaged with each other.

7. The recording apparatus according to claim 6, wherein the second position is opposite the recording area with the first position arranged therebetween.

8. The recording apparatus according to claim 1, further comprising:
a planetary gear configured to transmit the drive of the motor to the paper feeding unit; and
a planetary arm configured to rotatably support the planetary gear.

9. The recording apparatus according to claim 8, wherein the trigger arm includes an arm portion adapted to block the movement of the planetary arm by engaging with the planetary arm.

10. The recording apparatus according to claim 9, wherein the trigger arm is pivotable to a first state in which the arm portion is engaged with the planetary arm and to a second state in which the arm portion is separated from the planetary arm.

11. The recording apparatus according to claim 10, further comprising:
an urging unit configured to urge the trigger arm to the first state.
